(19) United States
(12) Patent Application Publication
(10) Pub. No.: US 2011/0196516 A1
(43) Pub. Date: Aug. 11, 2011

(54) SAFETY SYSTEM FOR A GARAGE DOOR

(75) Inventors: Dezhong Yang, Nanjing (CN); Wu Chen, Nanjing (CN)

(73) Assignee: CHERVON (HK) LIMITED, Wanchai (HK)

(21) Appl. No.: 13/015,827

(22) Filed: Jan. 28, 2011

(30) Foreign Application Priority Data
Feb. 10, 2010 (CN) 201010112031.8

(51) Int. Cl. E05F 15/20; G06F 17/00

(52) U.S. Cl. 700/90; 49/26

(57) ABSTRACT

A safety system for a garage door movable along a door frame is used to detect an obstacle. The safety system includes a motor device for opening and closing the garage door, a control circuit for controlling the motor to open and close the door, a light emitting device for emitting a light, a light receiving device in communication with the control circuit for receiving the light, wherein the light emitting device and the light receiving device are to be mounted on one side of the door frame, and an optical reflecting device for mounting on the other side of the door frame opposite to the light emitting device and the light receiving device whereby the light receiving device will receive light emitted from the light emitting device and reflected by the optical reflecting device. An optical element is to be mounted near the optical reflecting device for changing the polarization direction of the reflected light, and another optical element is to be mounted near the light receiving device to allow the light in only one polarization direction to pass there through.

### RELATED APPLICATION

This application claims the benefit of CN 201010112031.8, filed on Feb. 10, 2010, the disclosure of which is incorporated herein by reference in its entirety.

### BACKGROUND

The following generally relates to a safety system which functions to detect an obstacle to protect a garage door movable along a door frame.

In garage door systems a safety system is used to prevent a garage door from moving downward when there is an obstacle under the door. In existing garage door systems, such safety systems usually include a light emitting device and a light receiving device that are equipped on one side of the door frame and an optical reflecting device that is oppositely mounted on the other side of the door frame. If no obstacle is under the door, the light receiving device may receive the light emitted from the light emitting device and reflected by the light reflecting device and, in such case, the light receiving device sends a safety signal to the control circuit and the door will be operated normally. When there is an obstacle under the door, the light receiving device would not receive the light emitted from the light emitting device and reflected by the light reflecting device, and, at this time, the light receiving device sends a non-safety signal to the control circuit so that the control circuit will stop the motor or reverse the movement of the door. In this safety system for detecting an obstacle, when there is an obstacle under the door, the light emitted from the light emitting device would be reflected on the surface of the obstacle, and in such case, the light receiving device may still receive partial reflected light from a certain angle. Therefore, the door can still be operated normally with the obstacle under the door, which causes the incorrect operation and results in the danger.

### SUMMARY

The following discloses a safety system which, when there is an obstacle under the door, the light receiving device almost can not receive the reflected light reflected by the surface of the obstacle.

To this end, the safety system comprises a motor device for opening or closing the garage door, a control circuit mounted near the motor for controlling the motor to open or close the door, a light emitting device for emitting an emitted light, and a light receiving device communicated with the control circuit for receiving the light, wherein the light emitting device and the light receiving device are mounted on one side of the door frame, and an optical reflecting device is mounted on the other side of the door frame opposite to the light emitting device and the light receiving device. The light receiving device receives the reflected light emitted from the light emitting device and reflected by the optical reflecting device. An optical element is mounted near the optical reflecting device for changing the polarization direction of the reflected light, and another optical element is mounted near the light receiving device to allow the light in only one polarization direction to pass there through.

With the above system, the garage door will not be operated incorrectly when there is an obstacle under the door so as to improve the safety thereof.

### BRIEF DESCRIPTION OF THE DRAWINGS

FIG. 1 is a schematic view of an exemplary safety system for a garage door according to the description that follows;

FIG. 2 is an optical pathway diagram of the subject safety system for a garage door;

FIG. 3 is a schematic view illustrating light with a polarization direction changed by 90° which results according to the subject safety system for a garage door;

FIG. 4 is a circuit diagram of the light emitting device according to the subject safety system for a garage door;

FIG. 5 is a schematic view of a pulse-modulated signal of visible light emitted by the light emitting device of the subject safety system for a garage door; and

FIG. 6 is a schematic view of the pulse-modulated signal of invisible light emitted by the light emission device of the subject safety system for a garage door.

### DETAILED DESCRIPTION

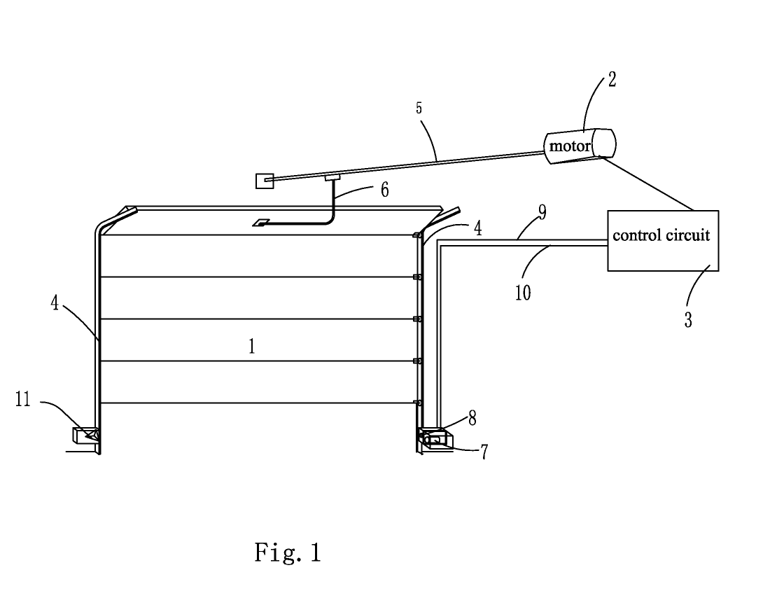

As shown in FIG. 1, a safety system for a garage door comprises a control circuit 3, a motor 2, a driving belt 5 attached to the motor 2, and a releasable driving arm 6 attached to the driving belt 5 and connected to the garage door 1, wherein the control circuit 3 controls the motor 2 according to received commands, and the driving arm 6 is driven by the motor 2 via the driving belt 5 to move and drive the garage door 1 to slide along the door frame 4, so as to open or close the garage door 1. When the garage door 1 is located in a fully opened position or a fully closed position, the control circuit 3 stops the movement of the motor 2 so as to stop the movement of the garage door 1. A light emitting device 7 and a light receiving device 8 are mounted near the bottom and also mounted on the same side of the door frame 4. The light emitting device 7 and the light receiving device 8 are electrically connected to the control circuit 3 by conducting wires 9 and 10 respectively, and are supplied with power by the control circuit 3 via the conducting wires 9 and 10. By the conducting wire 10, the light receiving device 8 can also communicate with the control circuit 3. Additionally, the light emitting device 7 and the light receiving device 8 can also be supplied with power directly by a separate power source. An optical reflecting device 11 is mounted on the other side of the door frame 4 opposite to the light emitting device 7 and the light receiving device 8. Preferably, the light reflecting device 11 is a straight taper prism or one of other reflectors.

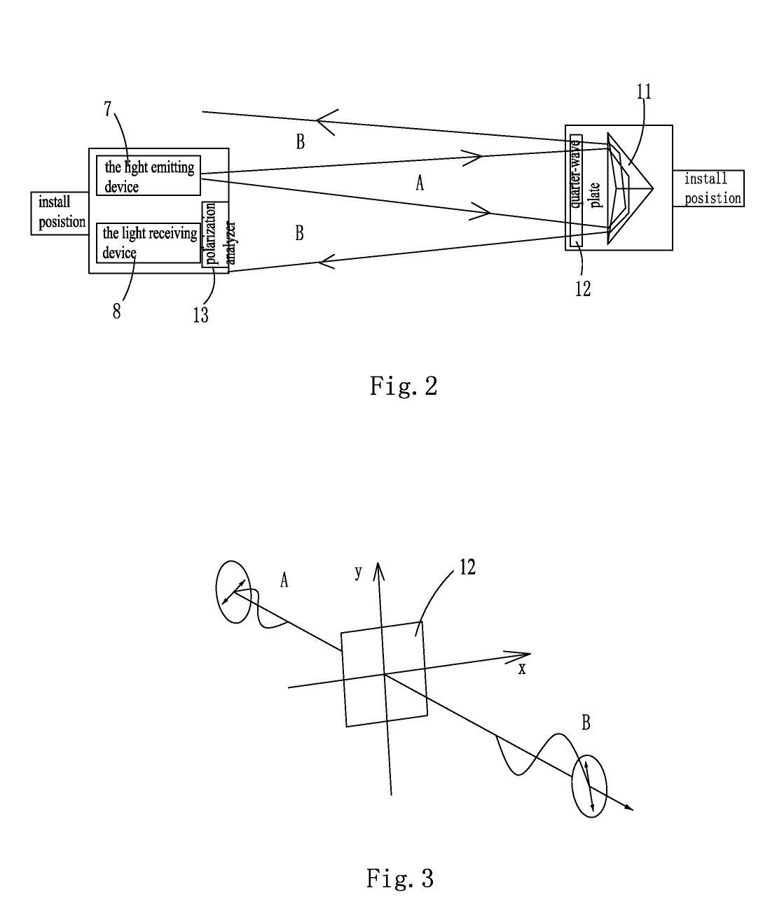

As shown in FIG. 2, the corresponding positions of the light emitting device 7, the light receiving device 8 and the straight taper prism 11 are illustrated. A quarter-wave plate 12 is mounted at the position near the straight taper prism 11 and opposite to the light emitting device 7 and the light receiving device 8. The quarter-wave plate 12 can also be another form of an optical rotation plate which can change the polarization direction of the light such as half-wave plate, or other optical element that can change the polarization direction of the light such as liquid crystal, etc. A polarization analyzer 13 is mounted at the position near the light receiving device 8 and opposite to the quarter-wave plate 12, which can also be substituted with other optical elements that allow the light in only one polarization direction to pass there through. The light emitting device 7 can be a laser emitting device, an infrared emitting device or other optical emitting devices. When the light emitting device 7 is switched on, the light emitting device 7 emits an emitted light A with an initial polarization direction U (as shown in FIG. 3), and the emitted light A is transmitted to the surface of the straight taper prism 11 with a polarization direction (U+45° after passing through the quarter-wave plate 12). A reflected light is formed after the light with the polarization direction U+45° is reflected by the straight taper prism 11 and a reflected light B (as shown in FIG. 3) in the polarization direction U+90° is formed after the reflected light passing through the quarter-wave plate 12. Since the polarization analyzer 13 mounted near the light receiving device 8 only allows the light in the phase U+90° to pass through, the reflected light B will pass through the polarization analyzer 13 so that the light receiving device 8 receives the light emitted from the light emitting device 7. When the light receiving device 8 receives a predetermined amount of light, the light receiving device 8 sends the safety signal to the control circuit 3 via the conducting wire 10 to open or close the door normally. If the light receiving device 8 does not receive a predetermined amount of light, the light receiving device 8 sends the non-safety signal to the control circuit 3 via the conducting wire 10 to stop or reverse the movement of the door. In addition, the emitted light A can merely pass through the quarter-wave plate 12 after being reflected rather than pass through the quarter-wave plate 12 before being transmitted to the straight taper prism 11. In such way, the polarization direction of the light will be changed to be U+45°, and then it will be feasible for a manipulator to arrange the polarization analyzer 13 mounted near the light receiving device 8 to allow the light in the phase U+45° to pass through.

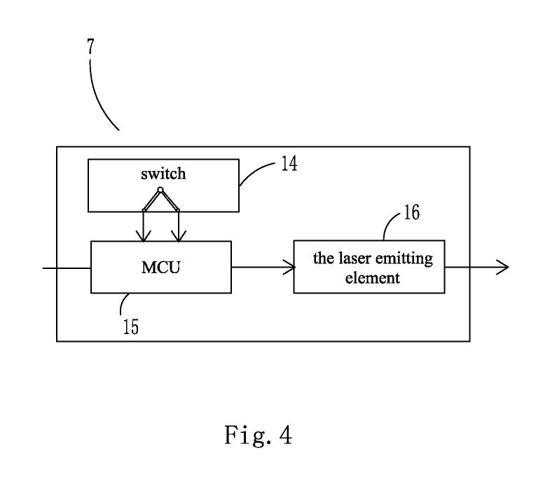

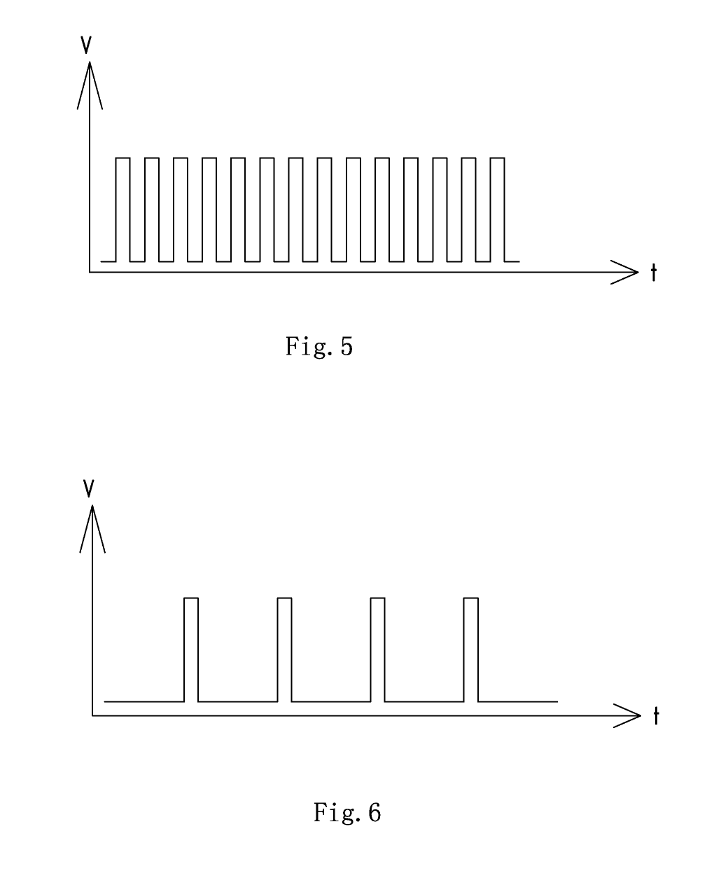

As shown in FIG. 4, a circuit diagram of the light emitting device 7 which is a laser emitting device is illustrated. The light emitting device 7 comprises a processor 15, a switch 14 and a laser emitting element 16, wherein the laser emitting element 16 and the switch 14 are respectively connected with the processor 15. When the switch 14 is located at the first position (the real line as shown in FIG. 4), the processor 15 drives the laser emitting element 16 with a higher duty cycle of the pulse-modulated signal (as shown in FIG. 5), and the laser emitting element 16 emits visible light; while the switch 14 is located at the second position (the dashed line as shown in FIG. 4), the processor 15 drives the laser emitting element 16 with a lower duty cycle of the pulse-modulated signal (as shown in FIG. 6) and the light emitted from the laser emitting element 16 is invisible. During mounting of the light emitting device 7, the installer first pushes the switch 14 to the first position and then the visible light is emitted from the light emitting device 7. Since the light emitted from the light emitting device 7 is visible, the manipulator can mount the straight taper prism 11 on the other side of the door frame with the visible light being transmitted to the straight taper prism 11. After mounting the straight taper prism 11 and other devices, the installer pushes the switch 14 to the second position. At this time, the light emitted from the light emitting device 7 is invisible, so that the light emitted from the light emitting device 7 is invisible during normal opening or closing of the door. Therefore, it is convenient for an installer to rapidly mount the device and a higher safety standard of laser is improved during opening or closing of the door.

The above description and the illustrations of the accompanying drawings are merely exemplary embodiments of the present invention and the protective scope of the present invention is to be based on the claims which follow. It will also be understood that the claims are additionally intended to cover circumstances wherein elements in the above description and shown in the accompanying drawings are substituted with like elements by those of ordinary person skill in the art.

What is claimed is:

1. A safety system for a garage door movable along a door frame used for detecting an obstacle, the safety system comprising:
a motor device for opening and closing the garage door;
a control circuit for controlling the motor to open and close the door;
a light emitting device for emitting a light;
a light receiving device in communication with the control circuit for receiving the light, wherein the light emitting device and the light receiving device are to be mounted on one side of the door frame; and
an optical reflecting device for mounting on the other side of the door frame opposite to the light emitting device and the light receiving device whereby the light receiving device will receive light emitted from the light emitting device and reflected by the optical reflecting device;
wherein an optical element is to be mounted near the optical reflecting device for changing the polarization direction of the reflected light, and another optical element is to be mounted near the light receiving device to allow the light in only one polarization direction to pass there through.

2. A safety system for a garage door movable along a door frame according to claim 1, wherein the optical reflecting device is a straight taper prism.

3. A safety system for a garage door movable along a door frame according to claim 1, wherein the optical element for changing the polarization direction of the light is an optical rotation plate.

4. A safety system for a garage door movable along a door frame according to claim 3, wherein the optical rotation plate is a quarter-wave plate.

5. A safety system for a garage door movable along a door frame according to claim 1, wherein the optical element for allowing the light in only one polarization direction to pass through is a polarization analyzer.

6. A safety system for a garage door movable along a door frame according to claim 1, wherein the light emitting device and the light receiving device are electrically connected to the control circuit.

7. A safety system for a garage door movable along a door frame according to claim 1, wherein the emitted light passes through the optical element for changing the polarization direction of the light.

8. A safety system for a garage door movable along a door frame according to claim 1, wherein the light emitting device is a laser emitting device.

9. A safety system of a garage door movable along a door frame according to claim 1, wherein the light emitting device comprises a processor, a switch, and a laser emitting element, the laser emitting element and the switch are connected to the processor respectively, the light emitted from the laser emitting element is visible when the switch is located at a first position and the light emitted from laser emitting element is invisible when the switch is located at a second position.
